(19) United States
(12) Patent Application Publication
(10) Pub. No.: US 2019/0211938 A1
(43) Pub. Date: Jul. 11, 2019

(54) Minimum Pressure Valve for a Screw Compressor for a Vehicle, in Particular a Utility Vehicle

(71) Applicant: KNORR-BREMSE Systeme fuer Nutzfahrzeuge GmbH, Muenchen (DE)

(72) Inventors: Gilles HEBRARD, Muenchen (DE); Jean-Baptiste MARESCOT, Muenchen (DE); Joerg MELLAR, Muenchen (DE); Thomas WEINHOLD, Muenchen (DE)

(21) Appl. No.: 16/353,848

(22) Filed: Mar. 14, 2019

Related U.S. Application Data
(63) Continuation of application No. PCT/EP2017/073593, filed on Sep. 19, 2017.

(30) Foreign Application Priority Data
Sep. 21, 2016 (DE) 10 2016 011 495.9
Mar. 1, 2017 (DE) 10 2017 104 203.2

(51) Int. Cl. F16K 15/02; F16K 17/06

(52) U.S. Cl. CPC F16K 15/023; F16K 17/06; F16K 15/028

(57) ABSTRACT

A minimum pressure valve for a screw compressor for a vehicle, in particular a utility vehicle, is provided with a housing; a valve insert opening which is formed in the housing; a valve insert which is inserted into the valve insert opening and has a valve piston bore; a valve piston, a valve piston section of which is guided in the valve insert in a movable manner in the valve piston bore; at least one fluid inlet channel; and at least one fluid outlet channel. The fluid inlet channel has at least one valve seat on the inlet channel end which faces the valve piston, wherein the valve piston can be set against the valve seat in order to close the minimum pressure valve such that the fluid inlet channel and the fluid outlet channel are separated in a closed position of the valve piston. The valve seat has a valve seat diameter dA, and the valve piston section has a valve piston section diameter dB. The ratio of the valve piston section diameter dB to the valve seat diameter dA ranges between ca. 0.6 and ca. 0.95.

### CROSS REFERENCE TO RELATED APPLICATIONS

This application is a continuation of PCT International Application No. PCT/EP2017/073593, filed Sep. 19, 2017, which claims priority under 35 U.S.C. § 119 from German Patent Applications Nos. 10 2016 011 495.9, and 10 2017 104 203.2, filed Sep. 21, 2016 and Mar. 1, 2017 respectively, the entire disclosures of which are herein expressly incorporated by reference.

### BACKGROUND AND SUMMARY OF THE INVENTION

The present invention relates to a minimum pressure valve for a compressor, in particular a screw compressor or a rotary vane compressor, for a vehicle, in particular a utility vehicle, having at least one housing and having at least one valve insert opening formed in the housing.

Minimum pressure valves for compressors such as, for example, screw compressors of vehicles, in particular utility vehicles, are already known from the prior art. Such screw compressors are used, for example, to provide the compressed air required for the brake system of the utility vehicle.

In this context, in particular oil-filled compressors, in particular also screw compressors, are known. The lubrication concept of such screw compressors provides for the oil required for the lubrication of the screws to initially be transported with the compressed air. Before the compressed air can be fed to the air treatment device, the oil is separated off from the compressed air in an oil separation device, and is returned from there, for example, to the integrated oil reservoir or to the screws of the screw compressor.

Since the air treatment device must be regenerated at regular intervals by ventilation, it is necessary for this purpose for the operation of the screw compressor to be stopped (proceeding from a certain deactivation pressure). The compressor is also stopped when the deactivation pressure for the air reservoirs is reached. To safeguard the pressure in the screw compressor in relation to the air treatment device, the screw compressor has a minimum pressure valve.

In this regard, DE 10 2014 118 267 A1 discloses a valve for regulating a fluid flow, wherein the valve has a housing for the connection of a fluid entry channel to a fluid exit channel, which housing has a valve piston bore for guiding a valve piston and has a cylindrical valve piston which is arranged axially movably in the valve piston bore and which has a valve disk arranged at a front end. The valve disk can be pressed by a pressure medium against a valve seat arranged between fluid entry channel and fluid exit channel. The field of use of the valve extends to compressed-air installations, for example compressed-air generating installations of rail vehicles, in particular to screw compressors.

Furthermore, DD 207 560 A5 discloses a control device for a compressor, in particular a screw compressor installation, with oil injection, having a minimum pressure valve which is arranged in the pressure line and the valve body of which is acted on on the consumer side by a pressure spring.

Furthermore, DE 28 22 779 A1 discloses a rotary compressor with oil sealing, which rotary compressor has a relief valve for throttling or shutting off the compressor inlet if the compressed pressure overshoots a predetermined value. Also disclosed is a minimum pressure valve which closes off an outlet channel in order to prevent a backflow out of the pressure line via an outlet chamber.

DE 31 46 535 A1 furthermore discloses a minimum pressure valve in a pressure line of a compressor, in the case of which control by exertion of pressure on the minimum pressure valve is provided in order to prevent compressed air from being able to emerge, even only briefly, into the pressure line upon the deactivation of the compressor.

DE 33 11 055 A1 discloses a compressor which operates with oil injection and in the case of which a facility is created to switch the compressor into a load-free idle state and to nevertheless provide compressed air immediately upon a resumption of the extraction of compressed air. In order to accelerate the switching of the compressor from the load-free idle state back to a load state upon the resumption of the extraction of compressed air, a sensing device is provided which is arranged at a minimum pressure valve in the compressed-air extraction line.

Further minimum pressure valves which are used in conjunction with compressors, in particular screw compressors, are known for example from DE 37 02 652 A1, DE 73 01 546 U, DE 80 15 773 U1, DE 81 34 215 U1, DE 603 04 555 T2, DE 10 2006 016 318 A1, DE 10 2014 118 266 B3 and EP 0 698 738 A2.

Such minimum pressure valves are installed for example in an outlet region of screw compressors, wherein the minimum pressure valves first open proceeding from a settable pressure threshold value such that, for example, correct lubrication of the screw compressor can be performed. Due to the difference between the effective pneumatic surface of a valve piston in an open state and in a closed state of the minimum pressure valve, and owing to friction influences, the opening pressure differs from the closing pressure considerably depending on the embodiment. This can give rise to pressure hysteresis, with typical values of, for example, approximately 4.5 to approximately 5 bar in the case of an opening pressure of, for example, approximately 10 bar.

During the regeneration of the air treatment device, a rapid pressure drop generally occurs in the air treatment device until the closing pressure of the minimum pressure valve is reached.

Due to this rapid pressure drop and the above-mentioned pressure hysteresis, oil can be conveyed to the compressor outlet, giving rise to the risk of the oil exiting the outlet of the screw compressor in excessively large quantities. Damage to or blockage of further pneumatic components, for example the air treatment device, connected to the screw compressor outlet can consequently occur.

A further undesired effect of the rapid pressure drop is foaming of the oil situated in the screw compressor, which can give rise to damage in particular to components of the screw compressor which are subject to wear owing to deficient lubrication, such as for example bearings or screws.

It is therefore the object of the present invention to advantageously further develop a minimum pressure valve for a screw compressor of a vehicle, in particular of a utility vehicle, of the type mentioned in the introduction, in particular such that hysteresis between an opening pressure and a closing pressure of the minimum pressure valve is reduced.

This object is achieved by a minimum pressure valve for a compressor, in particular a screw compressor or a rotary vane compressor, of a vehicle, in particular of a utility vehicle, having the claimed features. Provision is accordingly made for a minimum pressure valve for the screw compressor for the vehicle, in particular the utility vehicle. The minimum pressure valve has at least one housing, at least one valve insert opening which is formed in the housing, at least one valve insert which is inserted into the valve insert opening and which has at least one valve piston bore, at least one valve piston which is displaceably guided with at least one valve piston portion in the valve insert in the valve piston bore, at least one fluid entry channel and at least one fluid exit channel. The fluid entry channel has, at its end facing toward the valve piston, at least one valve seat against which the valve piston can be brought into abutment in order to close the minimum pressure valve, such that the fluid entry channel and the fluid exit channel are separated from one another in a closed position of the valve piston, wherein the valve seat has a valve seat diameter dA, wherein the valve piston portion has a valve piston portion diameter dB, and wherein the ratio of valve piston portion diameter dB to valve seat diameter dA lies between approximately 0.6 and approximately 0.95, preferably between approximately 0.7 and approximately 0.9, particularly preferably between approximately 0.8 and approximately 0.85.

The invention is based on the underlying concept of providing a minimum pressure valve for a compressor, in particular a screw compressor or a rotary vane compressor, the valve seat diameter of which has a specific ratio with respect to a diameter of a valve piston portion in order to minimize the pressure hysteresis of the minimum pressure valve. The pressure hysteresis arises firstly owing to the difference between the opening pressure and closing pressure resulting from different pneumatically effective surfaces of the valve piston in an open state and in a closed state. The pressure hysteresis is secondly influenced by friction influences of the valve piston portion which is guided displaceably in the valve piston bore in the valve insert. In this context, the inventors have surprisingly identified that the hysteresis of the minimum pressure valve can be reduced significantly to approximately 0.2 bar in the case of a ratio of valve piston portion diameter dB to valve seat diameter dA of approximately 0.82 (dB/dA=approximately 0.82). The valve piston portion diameter dB is thus configured to be smaller than the valve seat diameter dA, and is furthermore guided in axially displaceable fashion exclusively in the valve piston bore (that is to say additional friction surfaces are avoided) of the valve insert. By way of this structural design, an additional minimization of static and sliding friction of the valve piston can be achieved, which additionally has a positive effect on the pressure hysteresis of the minimum pressure valve, which is thus rendered practically negligible.

Provision may furthermore be made for the valve piston portion which is guided displaceably in the valve insert in the valve piston bore to be a free valve piston end portion. The displaceably guided valve piston portion is therefore designed as a free valve piston end portion because this simplifies the structural design of the minimum pressure valve. The free valve piston end portion is to be understood as being situated at that, in particular free, end of the valve piston portion which does not integrally adjoin the valve piston. In particular, the structural design of the valve insert, and the manufacture and assembly thereof, are simplified.

It is furthermore advantageous for at least one seal, in particular one radial seal, to be provided between the free valve piston end portion and the valve piston bore. The radial seal is advantageous for reliable functional fulfilment by the minimum pressure valve because, in particular in the case of pneumatic components which move radially and relative to one another (as in the present case of the valve piston and the valve insert), the radial seal generates a very good sealing action. Furthermore, the use of the radial seal permits a simpler construction of valve piston end portion and valve piston bore, and simplified assembly.

It is furthermore advantageous for the free valve piston end portion to have a cylindrical form and for the seal, in particular the radial seal, to be arranged in the shell surface of said valve piston end portion, which seal is pushed against the valve piston bore. Due to the cylindrical shape of the free valve piston end portion, it can be produced particularly easily using routine manufacturing methods (for example turning). The arrangement of the radial seal in the shell surface of the free valve piston portion is advantageous in particular owing to the relatively simple installation of the radial seal. The radial seal may be designed in the form of an O-ring and/or an Airzet ring. Other radial sealing concepts are however also contemplated in this context. Here, the radial seal may be mounted into the shell surface of the valve piston end portion, pulled on, clamped, screwed, clipped, adhesively bonded and/or vulcanized on.

Provision may furthermore be made for the valve seat to have an encircling, in particular a continuously encircling, elevation. The elevation of the sealing seat permits in particular an improved sealing action. Finally, by way of the elevation, the specific contact pressure on the components to be sealed can be increased in a simple and advantageous manner, whereby the sealing action is also increased.

It is furthermore advantageous for the valve piston to have at least one seal, in particular one axial seal, in its end surface facing toward the fluid entry channel, which seal is brought into abutment against the valve seat in the closed position of the valve piston. The use of an axial seal is advantageous in particular if two pneumatic components which are at least temporarily to be sealed and which are at rest relative to one another (in this case: valve piston and fluid entry channel) are brought into abutment. Since, in the present usage situation, the axial seal has to seal off the piston and valve seat not during the relative movement thereof but rather only when the piston has been brought into abutment, the axial seal can be designed so as to generate a very good sealing action. Here, the axial seal may be mounted into the end surface, pulled on, screwed, clipped, clamped, adhesively bonded and/or vulcanized on. Other fastening possibilities which are suitable in this context are likewise conceivable. The axial seal is of substantially ring-shaped form. Other forms of the axial seal (for example an O-ring, diaphragm seal or a sombrero) are however also contemplated.

It is likewise advantageous for an end of the valve piston bore to have an axial stop by which the axial displacement of the free valve piston end portion and of the valve piston can be limited. The provision of the valve piston bore with an axial stop is of major significance in particular because, in this way, it is possible in a structurally very simple manner to implement firstly the axial guidance and secondly the axial limitation of the valve piston in only one component and in particular with only one guide bore (specifically the valve piston bore). Furthermore, a geometrically defined stop of the valve piston or of the valve piston end portion is imperatively necessary for the reliable operation of the minimum pressure valve.

The stop may also be realized by virtue of the spring moving into a block state. It would also be possible for the spring to be situated in a (or the) valve piston bore. Then, the stop may also be realized between spring engagement surfaces.

Provision may furthermore be made for a spring element, in particular a helical spring, to be arranged between a spring engagement surface of the valve piston and a spring engagement surface of the valve insert. The spring element in the form of the helical spring is advantageous for the functional fulfilment by the present minimum pressure valve because the helical spring is, in the installed and assembled state, responsible for the abutment of the valve piston against the valve seat at the end of the fluid channel and for the opening and closing pressure. Furthermore, the use in the radially restricted space conditions within the valve insert opening is particularly advantageous because a helical spring is a radially compact, elongate machine element.

It is furthermore advantageous for at least one seal, in particular one radial seal, to be provided between the valve insert and the valve insert opening of the housing. As already described above, the valve insert is merely inserted into the valve insert opening, such that the valve insert opening, which is under operating pressure, must imperatively be sealed off with respect to the atmosphere. Furthermore, in the inserted state of the valve insert, only the radial surfaces of the valve insert and valve insert opening are in contact. Therefore, in the present case, it is particularly easy and advantageous for a further radial seal to be provided between valve insert and valve insert opening.

It is additionally advantageous for the valve insert to have a cylindrical outer contour and for the seal, in particular the radial seal, to be arranged in the shell surface of the valve insert, which seal is pushed against the valve insert opening in the assembled state of the minimum pressure valve. Due to the cylindrical outer contour of the valve insert, the latter can be very easily manufactured in an inexpensive and precise manner using routine manufacturing methods (for example turning). Furthermore, the arrangement of the radial seal in the shell surface of the valve insert is expedient in particular for simplifying the installation of the radial seal.

Provision may furthermore be made for the valve insert to have a ventilation bore which extends from an outer surface of the valve insert to the end, which has the axial stop, of the valve piston bore. In the assembled state of the minimum pressure valve, it is basically the case that a substantially cylindrical intermediate space is formed within the valve piston bore, which intermediate space is spatially delimited by an end side of the valve piston end portion, by the end of the valve piston bore, and by the valve piston bore. During the course of the operation of the minimum pressure valve, this cylindrical intermediate space discussed above is continuously charged with a certain fraction of the operating pressure, because the radial seal of the valve piston end portion cannot ensure absolute leak-tightness. If this cylindrical intermediate space were not continuously ventilated (for example in the present case through the ventilation bore), it would act as a type of gas spring on the end of the valve piston and thus in particular increase the pressure hysteresis of the minimum pressure valve rather than minimizing the influence thereof.

It is also contemplated that, in a surface of the valve insert opening, there is provided an axial stop, in particular an axial securing ring or a screw cover, against which the valve insert is brought into abutment axially in the assembled state of the minimum pressure valve. As already discussed above, the valve insert is merely inserted into the valve insert opening, whereby the housing of the minimum pressure valve must have a defined axial stop within the valve insert opening in order to ensure the function. The axial stop in the form of the axial securing ring is advantageous in particular owing to its very simple installation and accessibility in the present case and owing to the acceptable axial forces.

It is moreover advantageous for the housing of the minimum pressure valve to be formed as an integral constituent part of a housing of the screw compressor. The integral joining of the housing of the minimum pressure valve to a housing of the screw compressor results, in any case, in a simplification of the structural design of the minimum pressure valve and of the housing of the screw compressor. Since the separate housing of the minimum pressure valve can be omitted, the material requirement and assembly and manufacturing costs, and the number of parts, are additionally reduced as a result. Furthermore, the manufacture in particular of the valve insert opening can be simplified because, owing to the structural design, very good external accessibility of the housing of the minimum pressure valve and of the screw compressor can be realized.

Provision may furthermore be made for the minimum pressure valve to be designed as a minimum pressure corner valve. The embodiment as a minimum pressure corner valve is advantageous in particular because the minimum pressure valve as a whole is not flowed through axially, and thus the outlay in terms of construction can be considerably reduced, and furthermore the associated additional costs can be avoided. Owing to the considerably simpler structural design, functional reliability is furthermore increased.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a schematic sectional illustration of an exemplary embodiment of a screw compressor having a minimum pressure valve according to the invention.

FIG. 2 is a schematic cross-sectional view of an exemplary embodiment of a minimum pressure valve according to the invention in a closed position.

FIG. 3 is a schematic cross-sectional view of an exemplary embodiment of the minimum pressure valve according to the invention as per FIG. 2 in an opened position.

### DETAILED DESCRIPTION OF THE DRAWINGS

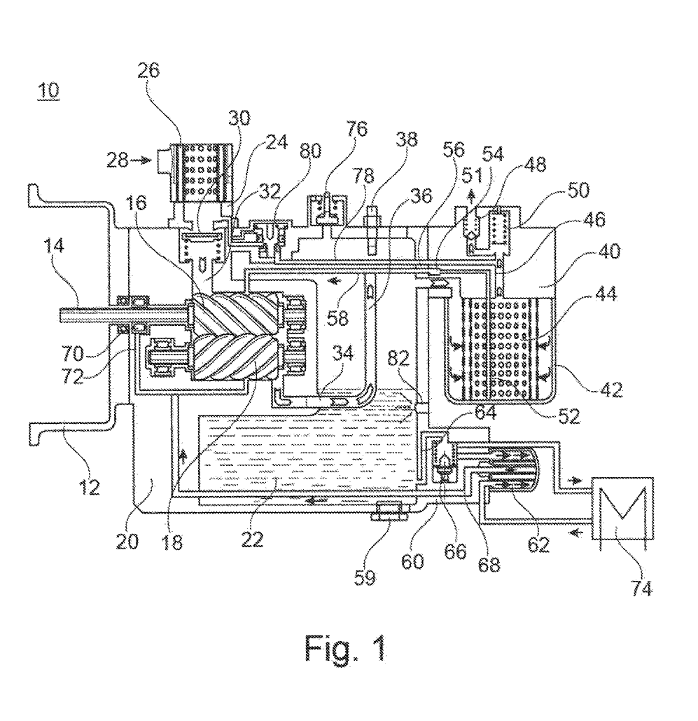

FIG. 1 shows, in a schematic sectional illustration, a screw compressor 10 which has a minimum pressure valve 50 according to the invention.

The screw compressor 10 has a fastening flange 12 for the mechanical fastening of the screw compressor 10 to a drive (not shown in any more detail here) in the form of an electric motor.

What is shown, however, is the input shaft 14, by which the torque from the electric motor is transmitted to one of the two screws 16 and 18, specifically the screw 16.

The screw 18 meshes with the screw 16 and is driven by means of the latter.

The screw compressor 10 has a housing 20 in which the main components of the screw compressor 10 are accommodated.

The housing 20 is filled with oil 22.

At the air inlet side, an inlet connector 24 is provided on the housing 20 of the screw compressor 10.

The inlet connector 24 is in this case designed such that an air filter 26 is arranged at the inlet connector.

Furthermore, an air inlet 28 is provided radially on the air inlet connector 24.

In the region between the inlet connector 24 and the point at which the inlet connector 24 joins to the housing 20, there is provided a spring-loaded valve insert 30, which is designed here as an axial seal.

The valve insert 30 serves as a check valve.

Located downstream of the valve insert 30 is an air feed channel 32 which feeds the air to the two screws 16, 18.

At the outlet side of the two screws 16, 18 an air outlet pipe 34 with a riser line 36 is provided.

In the region of the end of the riser line 36, a temperature sensor 38 is provided by which the oil temperature can be monitored.

Also provided in the air outlet region is a holder 40 for an air deoiling element 42.

In the assembled state, the holder 40 for the air deoiling element has the air deoiling element 42 in the region facing toward the base (as also shown in FIG. 1).

Also provided, in the interior of the air deoiling element 42, is a corresponding filter screen or known filter and oil separating devices 44, which will not be specified in any more detail.

In the central upper region in relation to the assembled and operationally ready state (that is to say as shown in FIG. 1), the holder for the air deoiling element 42 has an air outlet opening 46 which leads to a check valve 48 and a minimum pressure valve 50.

The check valve 48 and the minimum pressure valve 50 may also be formed in one common combined valve.

The air outlet 51 is provided downstream of the check valve 48.

The air outlet 51 is generally connected to correspondingly known compressed-air consumers.

In order for the oil 22 that is situated and separated off in the air deoiling element 42 to be returned into the housing 20, a riser line 52 is provided which has a filter and check valve 54 at the outlet of the holder 40 for the air deoiling element 42 at the transition into the housing 20.

A nozzle 56 is provided, downstream of the filter and check valve 54, in a housing bore.

The oil return line 58 leads back into approximately the central region of the screw 16 or of the screw 18 in order to feed oil 22 thereto again.

An oil drain screw 59 is provided within the base region, in the assembled state, of the housing 20.

By use of the oil drain screw 59, a corresponding oil outflow opening can be opened, via which the oil 22 can be drained.

Also provided in the lower region of the housing 20 is the attachment piece 60 to which the oil filter 62 is fastened.

Via an oil filter inlet channel 64, which is arranged in the housing 20, the oil 22 is conducted firstly to a thermostat valve 66.

Instead of the thermostat valve 66, it is also possible for an open-loop and/or closed-loop control device to be provided by which the oil temperature of the oil 22 situated in the housing 20 can be monitored and set to a setpoint value.

Downstream of the thermostat valve 66, there is then the oil inlet of the oil filter 62, which, via a central return line 68, conducts the oil 22 back to the screw 18 or to the screw 16 again, and also to the oil-lubricated bearing 70 of the shaft 14.

Also provided in the region of the bearing 70 is a nozzle 72, which is provided in the housing 20 in conjunction with the return line 68.

The cooler 74 is connected to the attachment piece 60.

In the upper region of the housing 20 (in relation to the assembled state), there is situated a safety valve 76, by which an excessively high pressure in the housing 20 can be dissipated.

Upstream of the minimum pressure valve 50, there is situated a bypass line 78, which leads to a relief valve 80.

Via the relief valve 80, which is activated by way of a connection to the air feed 32, air can be returned into the region of the air inlet 28.

In this region, there may be provided a ventilation valve (not shown in any more detail) and also a nozzle (diameter constriction of the feeding line).

Furthermore, approximately at the level of the line 34, an oil level sensor 82 may be provided in the outer wall of the housing 20.

The oil level sensor 82 may for example be an optical sensor, and may be designed and configured such that, on the basis of the sensor signal, it can be identified whether the oil level during operation is above the oil level sensor 82 or whether the oil level sensor 82 is exposed, and thus the oil level has correspondingly fallen.

In conjunction with this monitoring, it is also possible for an alarm unit to be provided which outputs or transmits a corresponding error message or fault message to the user of the system.

The function of the screw compressor 10 shown in FIG. 1 is as follows.

Air is fed via the air inlet 28 and passes via the check valve 30 to the screws 16, 18, where the air is compressed.

The compressed air-oil mixture, which, having been compressed by a factor of between 5 and 16 downstream of the screws 16 and 18, rises through the outlet line 34 via the riser pipe 36, and is blown directly onto the temperature sensor 38.

The air, which still partially carries oil particles, is then conducted via the holder 40 into the air deoiling element 42 and, if the corresponding minimum pressure is attained, passes into the air outlet line 51.

The oil 22 situated in the housing 20 is kept at operating temperature via the oil filter 62 and possibly via the heat exchanger 74.

If no cooling is necessary, the heat exchanger 74 is not used and is also not activated.

The corresponding activation is performed by way of the thermostat valve 66. After purification in the oil filter 62, oil is fed via the line 68 to the screw 18 or to the screw 16, and also to the bearing 70.

The screw 16 or the screw 18 is supplied with oil 22 via the return line 52, 58, and the purification of the oil 22 takes place here in the air deoiling element 42.

By way of the electric motor (not shown in any more detail), which transmits its torque via the shaft 14 to the screw 16, which in turn meshes with the screw 18, the screws 16 and 18 of the screw compressor 10 are driven.

By way of the relief valve 80 (not shown in any more detail), it is ensured that the high pressure that prevails for example at the outlet side of the screws 16, 18 in the operational state cannot be enclosed in the region of the feed line 32, and that, instead, in particular during the start-up of the compressor, there is always a low inlet pressure, in particular atmospheric pressure, prevailing in the region of the feed line 32.

Otherwise, upon a start-up of the compressor, a very high pressure would initially be generated at the outlet side of the screws 16 and 18, which would overload the drive motor.

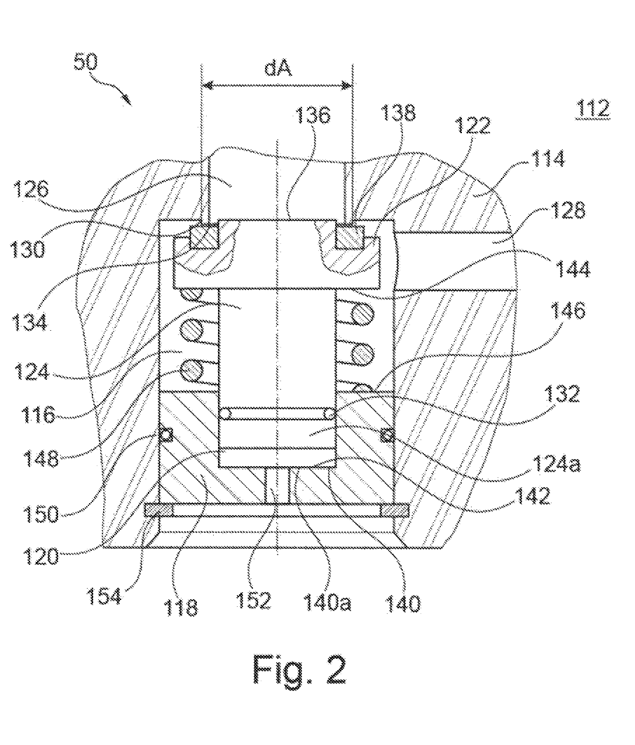

FIG. 2 shows a schematic cross-sectional view of an exemplary embodiment of a minimum pressure valve 50 according to the invention for a screw compressor 112 for a utility vehicle in a closed position.

Such a minimum pressure valve 50 may basically also be used in conjunction with a so-called rotary vane compressor.

The minimum pressure valve 50 has a (valve) housing 114 and a valve insert opening 116, which is formed in the housing 114.

The valve insert opening 116 is formed into the housing 114 as a cylindrical counterbore with one open and with one partially closed end.

The open end is arranged opposite the partially closed end.

Furthermore, the minimum pressure valve 50 has a valve insert 118 which is inserted into the valve insert opening 116.

The valve insert 118 has substantially a U-shaped cross section and a cylindrical outer contour and is of rotationally symmetrical form.

Furthermore, the valve insert 118 has, in its assembled state, an outer planar end side and an inner planar end side, which axially delimit the valve insert 118.

The valve insert opening 116 and the valve insert 118 are oriented coaxially with respect to one another.

Furthermore, the valve insert 118 has a valve piston bore 120.

The valve piston bore 120 is formed as a cylindrical and centrally arranged counterbore perpendicularly into the inner planar end side of the valve insert 118.

The valve piston bore 120 in turn has one open and one partially closed end.

Furthermore, the minimum pressure valve 50 has a valve piston 122, which furthermore comprises a valve piston portion 124.

The valve piston 122 is formed substantially as a disk-like cylinder.

In FIG. 2, the minimum pressure valve 50 is shown in a closed position of the piston 122.

The valve piston portion 124 rises from an end side, facing toward the valve insert 118, of the valve piston 122.

The valve piston portion 124 is formed as an elongate cylinder and is connected integrally and coaxially to the valve piston 122.

The valve piston portion 124 is furthermore guided in axially displaceable fashion in the valve piston bore 120 in the valve insert 118.

Furthermore, the minimum pressure valve 50 has a fluid entry channel 126 and a fluid exit channel 128.

The fluid is air or an air/oil mixture.

The fluid entry channel 126 is formed as a bore in the housing 114 and opens through the partially closed end into the valve insert opening 116.

A central axis of the fluid entry channel 126 and a central axis of the valve insert opening 116 are oriented substantially coaxially with respect to one another.

The fluid entry channel 128 is likewise formed as a bore in the housing 114 and opens radially into the valve insert opening 116.

A central axis of the fluid exit channel 128 is oriented substantially perpendicular to the central axis of the valve insert opening 116.

The fluid entry channel 126 furthermore has a valve seat 130 at its end facing toward the valve piston 122.

Here, the valve seat 130 is formed in the partially closed end of the valve insert opening 116 in the housing 114.

The valve piston 122 can be brought into abutment against the valve seat 130 in order to close the minimum pressure valve 50.

The valve seat 130 furthermore has a valve seat diameter dA.

Furthermore, the valve piston portion 124 has a valve piston portion diameter dB.

The ratio of valve piston portion diameter dB to valve seat diameter dA lies between approximately 0.7 and approximately 0.9 (dB/dA=approximately 0.7 . . . approximately 0.9).

The ratio of valve piston portion diameter dB to valve seat diameter dA particularly preferably lies between approximately 0.8 and approximately 0.85 (dB/dA=approximately 0.8 . . . approximately 0.85).

The valve piston portion 124 which is displaceably guided in the valve insert 118 in the valve piston bore 120 is furthermore a free valve piston end portion 124a.

A radial seal 132 is provided between the free valve piston end portion 124a and the valve piston bore 120.

The free valve piston end portion 124a has a cylindrical form.

The radial seal 132 is arranged in the shell surface of the free valve piston end portion 124a, which seal is pressed against the valve piston bore 120.

Furthermore, the shell surface of the free valve piston end portion 124a, which is situated within the valve piston bore 120, has a radially continuously encircling receiving groove in which the radial seal 132 is arranged.

The radial seal 132 is formed as an O-ring composed of an elastomer, in particular rubber.

The valve seat 130 furthermore has a continuously encircling elevation 134.

The elevation 134 is formed substantially as an at least partially formed torus.

The at least partially formed torus is, with its planar surface at the end of the fluid entry channel 126 in the housing 114, attached to the partially closed end of the valve insert opening 116.

The valve piston 122 has an axial seal 138 in its end side 136 facing toward the fluid entry channel 126, which seal is brought into abutment against the valve seat 130 in the closed position of the valve piston 122.

The valve seat diameter dA is thus slightly larger than the diameter of the fluid entry channel 126.

The axial seal 138 is of ring-shaped form and is arranged in a ring-shaped groove formed in an end side 136, facing toward the fluid entry channel 126, of the valve piston 122.

The axial seal 138 is formed from an elastomer, in particular rubber.

Furthermore, an end 140 of the valve piston bore 120 has an axial stop 142.

The stop may also be realized by virtue of the spring moving into a block state. It would also be possible for the spring to be situated in the valve piston bore 120. Then, the stop may also be realized between the spring engagement surface 144 and the spring engagement surface 146.

The end 140 of the valve piston bore 120 is formed as a partially closed end 140a.

The axial stop 142 is formed, within the partially closed end 140a, as a ring-shaped axial delimiting surface.

Furthermore, a helical spring 148 is arranged between a spring engagement surface 144 of the valve piston 122 and a spring engagement surface 146 of the valve insert 118.

Here, the spring engagement surface 144 of the valve piston 122 is formed as a planar outer ring-shaped surface on that end side of the valve piston 122 which faces toward the valve insert 118, said spring engagement surface radially surrounding a fastened end of the valve piston portion 124.

The spring engagement surface 146 of the valve insert 118 is formed as an outer ring-shaped surface of the inner end side of the valve insert 118, and radially borders the open end of the valve piston bore 120.

Furthermore, a radial seal 150 is provided between the valve insert 118 and the valve insert opening 116 of the housing 114.

The radial seal 150 is arranged in the shell surface of the cylindrical outer contour of the valve insert 118, and in the assembled state of the minimum pressure valve 50 is pressed against the valve insert opening 116.

The cylindrical outer contour of the valve insert 118 has a continuously running ring-shaped groove in which the radial seal 150 is arranged.

The radial seal 150 is formed as an O-ring composed of an elastomer, in particular rubber.

The valve insert 118 furthermore has a ventilation bore 152, which extends from an outer surface of the valve insert 118 to the partially closed end 140a of the valve piston bore 120.

The ventilation bore 152 is formed as a central, circular and coaxial passage bore in the valve insert 118.

In a surface of the valve insert opening 116, there is provided an axial securing ring 154 against which the valve insert 118 is brought into abutment axially in the assembled state thereof.

The valve insert 118, in the assembled state thereof, is brought into abutment axially by way of its outer end side against the securing ring 154.

Within the radial surface of the valve insert opening 116, in the vicinity of the open end of the valve insert opening 116, there is formed a continuously radially encircling receiving groove in which the securing ring 154 is arranged.

The housing 114 of the minimum pressure valve 50 is formed as an integral constituent part of a housing 20 of the screw compressor 112.

The minimum pressure valve 50 is furthermore formed as a minimum pressure corner valve 50.

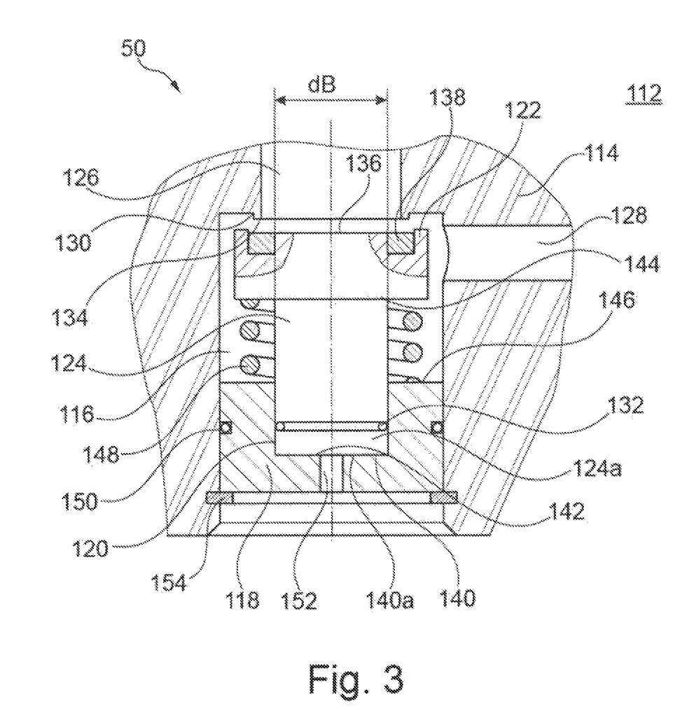

FIG. 3 shows an exemplary embodiment of the minimum pressure valve 50 according to the invention as per FIG. 2 in an opened position.

The function of the minimum pressure valve 50 can be described as follows.

The fluid entry channel 126 is fluidically connected to a pressure side of the screw compressor 112.

As soon as the operation of the screw compressor 112 has begun, compressed air flows from the pressure side of the screw compressor 112 into the fluid entry channel 126 and, there, at the valve seat 130, exerts operating pressure on that end side of the valve piston 122 which faces toward the fluid entry channel 126.

The pressure force resulting from the respective operating pressure and the valve seat diameter dA must firstly increase at least until it overshoots the sum of the spring force exerted by the helical spring 148 on the valve piston 122, of the circular ring area dA-dB and of the friction force between the seal element 132 and the valve insert 118.

For as long as this is not the case, the valve piston 122 is situated in a closed position, such that the fluid entry channel 126 and the fluid exit channel 128 are separated from one another.

If the pressure force (for example proceeding from an operating pressure of approximately 10 bar) overshoots the sum of the spring force of the spring element 148, of the pressure force resulting from the ring area dA-dB and of the friction force between the seal element 132 and the valve insert 118, the valve piston 122 moves axially in the direction of the valve insert 118 by virtue of the fact that said valve piston is guided in axially displaceable fashion by way of the valve piston end portion 124a in the valve piston bore 120.

Proceeding from a particular displacement length which is dependent predominantly on the operating pressure, the axial displacement of the valve piston 122 is limited by the axial stop 142 in the partially closed end 140a of the valve piston bore 120.

In this respect, the axial displacement of the free valve piston end portion 124a and of the valve piston 122 can be limited by way of the axial stop 142.

The compressed air then flows from the fluid entry channel 126 via the valve insert opening 116 into the fluid exit channel 128, and can be fed there to further pneumatic components (such as for example an air treatment device).

If the operating pressure of the screw compressor 112 falls below the value proceeding from which the sum of the spring force of the helical spring 148 and of the pressure force of the ring area dA-dB overshoots the sum of the pressure force on the valve piston 122 resulting from the diameter dB and the friction force between the seal element 132 and the valve insert 118, the valve piston 122 moves in the direction of the valve seat 130.

Finally, after the axial seal 138 has been brought into abutment against the valve seat 130, the valve piston 122 reaches its closed position.

Since the pneumatic effective area on that end side of the valve piston 122 which faces toward the fluid entry channel 126 is smaller in the open position of said valve piston than that in its closed position, the opening pressure consequently differs from the closing pressure (this is the case in any valve of this type of construction owing to the operating principle).

This discrepancy, which is referred to as hysteresis, should be kept as small as possible, and it is possible in particular by means of the ratio of valve piston portion diameter dB to valve seat diameter dA to achieve that the hysteresis can be reduced to values of approximately 1 bar, in particular approximately 0.5 bar, particularly preferably 0.2 bar, in the case of an opening pressure of approximately 10 bar.

### LIST OF REFERENCE DESIGNATIONS

10 Screw compressor
12 Fastening flange
14 Input shaft
16 Screw
18 crew
20 Housing
22 Oil
24 Inlet connector
26 Air filter
28 Air inlet
30 Valve insert
32 Air feed channel
34 Air outlet pipe
36 Riser line
38 Temperature sensor
40 Holder for an air deoiling element
42 Air deoiling element
44 Filter screen or known filter or oil separation devices
46 Air outlet opening
48 Check valve
50 Minimum pressure valve, minimum pressure corner valve
51 Air outlet
52 Riser line
54 Filter and check valve
56 Nozzle
58 Oil return line
59 Oil drain screw
60 Attachment piece
62 Oil filter
64 Oil filter inlet channel
66 Thermostat valve
68 Return line
70 Bearing
72 Nozzle
74 Cooler, heat exchanger
76 Safety valve
78 Bypass line
80 Relief valve
82 Oil level sensor
112 Screw compressor
114 (Valve) housing
116 Valve insert opening
118 Valve insert
120 Valve piston bore
122 Valve piston
124 Valve piston portion
124a Free valve piston end portion
126 Fluid entry channel
128 Fluid exit channel
130 Valve seat
132 Radial seal of the free valve piston end portion
134 Elevation of the valve seat
136 End surface of the valve piston
138 Axial seal of the valve piston
140 End of the valve piston bore
140a Partially closed end of the valve piston bore
142 Axial stop of the end of the valve piston bore
144 Spring engagement surface of the valve piston
146 Spring engagement surface of the valve insert
148 Spring element, helical spring
150 Radial seal of the valve insert
152 Ventilation bore
154 Axial securing ring
dA Valve seat diameter
dB Valve piston portion diameter

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A minimum pressure valve for a compressor for a vehicle, comprising:
at least one valve housing;
at least one valve insert opening which is formed in the valve housing;
at least one valve insert which is inserted into the valve insert opening and which has at least one valve piston bore;
at least one valve piston which is displaceably guided with at least one valve piston portion in the valve insert in the valve piston bore;
at least one fluid entry channel and at least one fluid exit channel, wherein the fluid entry channel has, at an end facing toward the valve piston, at least one valve seat against which the valve piston is brought into abutment in order to close the minimum pressure valve, such that the fluid entry channel and the fluid exit channel are separated from one another in a closed position of the valve piston, and
the valve seat has a valve seat diameter dA, wherein the valve piston portion has a valve piston portion diameter dB, and wherein the ratio of valve piston portion diameter dB to valve seat diameter dA lies between approximately 0.6 and approximately 0.95.

2. The minimum pressure valve as claimed in claim 1, wherein
the ratio is between approximately 0.7 and approximately 0.9.

3. The minimum pressure valve as claimed in claim 1, wherein
the ratio is between approximately 0.8 and approximately 0.85.

4. The minimum pressure valve as claimed in claim 1, wherein
the valve piston portion which is displaceably guided in the valve insert in the valve piston bore is a free valve piston end portion.

5. The minimum pressure valve as claimed in claim 4, wherein
at least one seal is provided between the free valve piston end portion and the valve piston bore.

6. The minimum pressure valve as claimed in claim 5, wherein
the at least one seal is a radial seal.

7. The minimum pressure valve as claimed in claim 5, wherein
the free valve piston end portion has a cylindrical form and the seal is arranged in a shell surface of said valve piston end portion, which seal is pushed against the valve piston bore.

8. The minimum pressure valve as claimed in claim 7, wherein
the valve seat has an encircling elevation.

9. The minimum pressure valve as claimed in claim 8, wherein
the valve seat has a continuously encircling elevation.

10. The minimum pressure valve as claimed in claim 8, wherein
the valve piston has at least one seal in its end surface facing toward the fluid entry channel, which seal is brought into abutment against the valve seat in a closed position of the valve piston.

11. The minimum pressure valve as claimed in claim 10, wherein
the at least one seal of the valve piston is an axial seal.

12. The minimum pressure valve as claimed in claim 10, wherein
an end of the valve piston bore has an axial stop by which axial displacement of the free valve piston end portion and of the valve piston is limitable.

13. The minimum pressure valve as claimed in claim 12, wherein
a helical spring is arranged between a spring engagement surface of the valve piston and a spring engagement surface of the valve insert.

14. The minimum pressure valve as claimed in claim 13, wherein
at least one radial seal is provided between the valve insert and the valve insert opening of the valve housing.

15. The minimum pressure valve as claimed in claim 14, wherein
the valve insert has a cylindrical outer contour and the radial seal is arranged in the shell surface of said valve insert, which radial seal is pushed against the valve insert opening in the assembled state of the minimum pressure valve.

16. The minimum pressure valve as claimed in claim 15, wherein
the valve insert has a ventilation bore which extends from an outer surface of the valve insert to the end, which has the axial stop, of the valve piston bore.

17. The minimum pressure valve as claimed in claim 16, wherein
in a surface of the valve insert opening, there is provided an axial stop against which the valve insert is brought into abutment axially in the assembled state of the minimum pressure valve.

18. The minimum pressure valve as claimed in claim 17, wherein
the axial stop is an axial securing ring.

19. The minimum pressure valve as claimed in claim 1, wherein
the valve housing of the minimum pressure valve is formed as an integral constituent part of a housing of a screw compressor.

20. The minimum pressure valve as claimed in claim 1, wherein
the minimum pressure valve is designed as a minimum pressure corner valve.
